(19) United States
(12) Patent Application Publication
(10) Pub. No.: US 2012/0077018 A1
(43) Pub. Date: Mar. 29, 2012

(54) ADHESIVE LAYER, ADHESIVE MEMBER, METHOD FOR PRODUCING SAME, AND IMAGE DISPLAY

(75) Inventors: Yousuke Makihata, Ibaraki-shi (JP); Kenichi Okada, Ibaraki-shi (JP); Toshitaka Takahashi, Ibaraki-shi (JP); Yoshiaki Kitani, Ibaraki-shi (JP); Taiki Shimokuri, Ibaraki-shi (JP); Yoshihiro Kitamura, Ibaraki-shi (JP)

(73) Assignee: NITTO DENKO CORPORATION, Ibaraki-shi, Osaka (JP)

(21) Appl. No.: 13/376,308

(22) PCT Filed: May 14, 2010
(86) PCT No.: PCT/JP2010/058170

§ 371 Date: Dec. 5, 2011

(30) Foreign Application Priority Data
Jun. 5, 2009 (JP) 2009-136575

(51) Int. Cl. C09J 7/02; C09J 133/08; C09J 143/04; B32B 3/26; B05D 5/10

(52) U.S. Cl. 428/317.5; 427/208.4; 427/162; 524/547; 524/560

(57) ABSTRACT

A pressure-sensitive adhesive layer of the invention includes product formed by applying an aqueous dispersion type pressure-sensitive adhesive including a dispersion containing at least a base polymer dispersed in water and by drying the applied aqueous dispersion type pressure-sensitive adhesive, the pressure-sensitive adhesive layer dose not contain air bubbles with a maximum length of more than 350 μm and the number of air bubbles with a maximum length of 50 μm to 350 μm is 1/m² or less in a surface of the pressure-sensitive adhesive layer. The pressure-sensitive adhesive layer is formed using an aqueous dispersion type pressure-sensitive adhesive with low environmental loading and has a high-quality coating appearance with no problem of fine air bubble defects.

### TECHNICAL FIELD

The invention relates to a pressure-sensitive adhesive layer obtained using an aqueous dispersion type pressure-sensitive adhesive. The invention also relates to a pressure-sensitive adhesive member having the pressure-sensitive adhesive layer provided on a base substrate and to a method for production thereof. The pressure-sensitive adhesive layer may be used in various applications, and for example, it may be used to form a pressure-sensitive adhesive member, which includes a base substrate and the pressure-sensitive adhesive layer provided on one or both sides of the base substrate as mentioned above, or to form a substrate-less double-faced adhesive layer or a double-faced pressure-sensitive adhesive tape which includes a base substrate and the pressure-sensitive adhesive layers provided on both sides of the base substrate. In the pressure-sensitive adhesive member, for example, an optical film, a surface protecting film substrate, a separator, or any other base material may be used as the base substrate. Examples of the optical film include a polarizing plate, a retardation plate, an optical compensation film, a brightness enhancement film, a prism sheet, a transparent conductive film for use in a touch panel, and a laminate thereof. In particular, the pressure-sensitive adhesive member including the pressure-sensitive adhesive layer formed on an optical film used as the base substrate is useful as a pressure-sensitive adhesive optical film, which can be used in an image display such as a liquid crystal display, an organic electroluminescence (EL) display, or a PDP. Examples of the surface protecting film include various plastic films suitable for use in the above optical films and so on.

### BACKGROUND ART

In a process of forming an image display such as a liquid crystal display, various optical films such as polarizing plates and retardation plates used to form the device are bonded to an adherend such as a liquid crystal cell with a pressure-sensitive adhesive layer interposed therebetween. In many cases, a pressure-sensitive adhesive is previously provided in the form of a pressure-sensitive adhesive layer on one side of an optical film, because it has some advantages such as the ability to instantaneously fix the optical film to a display panel such as a liquid crystal cell and no need to use a drying process for the fixation of the optical film. A surface protecting film for use in protecting an optical film or the like also has a pressure-sensitive adhesive layer.

In such applications, the pressure-sensitive adhesive layer is also required to have a high-quality coating appearance, because images are displayed through the pressure-sensitive adhesive layer and the optical film is inspected through the pressure-sensitive adhesive layer. For example, a defect such as an air bubble or a foreign body present in the pressure-sensitive adhesive layer may cause a defect in image display, so that a problem may occur, such as a reduction in the commercial value of the image display or failure to properly inspect the optical film.

Conventionally, organic solvent-containing pressure-sensitive adhesives, which are produced using an organic solvent, have been used in forming pressure-sensitive adhesive layers for the above applications, because they can easily achieve a high-quality coating appearance (Patent Documents 1 to 3).

On the other hand, in recent years, there has been a need to reduce the use of organic solvents in view of environmental loading, and therefore, there has been a need to replace the organic solvent-containing pressure-sensitive adhesive with an aqueous dispersion type pressure-sensitive adhesive which is produced using water as a dispersion medium and contains a pressure-sensitive adhesive component dispersed in water. Unfortunately, an aqueous dispersion type pressure-sensitive adhesive, which contains not only a pressure-sensitive adhesive component but also a surfactant for dispersing the pressure-sensitive adhesive component into water, has a tendency to foam easily, and the pressure-sensitive adhesive layer obtained using such an aqueous dispersion type pressure-sensitive adhesive is got with fine air bubbles. Therefore, since it is difficult to form a pressure-sensitive adhesive layer with a high quality appearance using an aqueous dispersion type pressure-sensitive adhesive, aqueous dispersion type pressure-sensitive adhesives have been used in applications where the demand for a high quality appearance is relatively not strong, such as pressure-sensitive adhesive labels, paper substrate tapes, and foams (Patent Documents 4 to 7).

Recently, there have been advances in the use of aqueous dispersion type pressure-sensitive adhesives in applications where a good coating appearance is required, such as transparent tapes, industrial surface-protecting tapes, and tapes for semiconductor wafer processing (Patent Documents 8 to 11), but no aqueous dispersion type pressure-sensitive adhesive capable of achieving a coating appearance suitable for use in optical applications has been obtained yet. Particularly, in recent years, as the size of image displays has increased, even a pressure-sensitive adhesive layer to be applied to a large-size optical film has been required to be formed with a good coating appearance and a high yield in view of production efficiency, etc. This makes it difficult to use aqueous dispersion type pressure-sensitive adhesives in optical applications.

### PRIOR ART DOCUMENTS

### Patent Documents

Patent Document 1: Japanese Patent No. 3533589
Patent Document 2: Japanese Patent No. 4017156
Patent Document 3: Japanese Patent No. 3916638
Patent Document 4: Japanese Patent Application Publication (JP-B) No. 01-51512
Patent Document 5: Japanese Patent No. 2800494
Patent Document 6: Japanese Patent No. 4225388
Patent Document 7: Japanese Patent No. 4087599
Patent Document 8: Japanese Patent Application Laid-Open (JP-A) No. 2005-179412
Patent Document 9: Japanese Patent No. 3810490
Patent Document 10: Japanese Patent No. 2968879
Patent Document 11: Japanese Patent No. 3908929

### SUMMARY OF THE INVENTION

### Problems to be Solved by the Invention

An object of the invention is to provide a pressure-sensitive adhesive layer that is formed using an aqueous dispersion type pressure-sensitive adhesive with low environmental loading and has a high-quality coating appearance with no problem of fine air bubble defects.

Another object of the invention is to provide a pressure-sensitive adhesive member having such a pressure-sensitive adhesive layer, to provide a method for production thereof, and to provide an image display produced using a pressure-sensitive adhesive optical film as the pressure-sensitive adhesive member.

### Means for Solving the Problems

As a result of earnest studies to solve the above problems, the inventors have found the pressure-sensitive adhesive layer and other features described below to accomplish the invention.

The inventions relates to a pressure-sensitive adhesive layer, including a product formed by applying an aqueous dispersion type pressure-sensitive adhesive including a dispersion containing at least a base polymer dispersed in water and by drying the applied aqueous dispersion type pressure-sensitive adhesive,

the pressure-sensitive adhesive layer dose not contain air bubbles with a maximum length of more than 350 μm and the number of air bubbles with a maximum length of 50 μm to 350 μm is 1/m² or less in a surface of the pressure-sensitive adhesive layer.

Although formed using an aqueous dispersion type pressure-sensitive adhesive, the pressure-sensitive adhesive layer of the invention is free of air bubbles with a maximum length of more than 350 μm, which will cause appearance defects in optical applications, and therefore has an appearance at a satisfactory level for optical applications. As the lower limit of the maximum length of air bubbles that the pressure-sensitive adhesive layer does not contain decreases, appearance defects become less likely to be observed. Therefore, the lower limit of the maximum length of air bubbles is preferably not more than 150 μm, more preferably not more than 100 μm.

The lower limit of the maximum length of air bubbles that the pressure-sensitive adhesive does not contain may be set to a small value, depending on the intended use of the pressure-sensitive adhesive layer. For example, when the pressure-sensitive adhesive layer is used to form an optical film, the lower limit may be determined depending on the size of the optical film. As the size of the optical film decreases, the lower limit of the maximum length of the air bubbles is preferably set to a smaller value. For example, when the optical film has a large size (20-42 inch size), the pressure-sensitive adhesive layer is preferably free of air bubbles with a maximum length of more than 350 μm; when the optical film has a middle size (10-20 inch size), the pressure-sensitive adhesive layer is preferably free of air bubbles with a maximum length of more than 150 μm; when the optical film has a small size (mobile size), the pressure-sensitive adhesive layer is preferably free of air bubble with a maximum length of more than 100 μm.

The pressure-sensitive adhesive layer may also have a surface in which the number of air bubbles with a maximum length of 50 to 350 μm is 1/m² or less.

Air bubbles with a maximum length of less than 50 μm are not visually identified as appearance defects even at a level for optical applications. On the other hand, even when the pressure-sensitive adhesive layer contains air bubbles with a maximum length of 50 to 350 μm, a large number of them are not preferred in terms of appearance. Therefore, the number of air bubbles with a maximum length of 50 to 350 μm in the surface of the pressure-sensitive adhesive layer is preferably 1/m² or less, more preferably 0.5/m² or less, even more preferably 0.1/m² or less. According to the number of the air bubbles, the maximum length of the air bubbles in the pressure-sensitive adhesive layer can be set small, depending on the intended use of the pressure-sensitive adhesive layer, as mentioned above. When the maximum length of air bubbles is in the range of 50 to 150 μm or preferably in the range of 50 to 100 μm, the above number of the air bubbles should be satisfied.

In the pressure-sensitive adhesive layer, the base polymer in the aqueous dispersion type pressure-sensitive adhesive is preferably a (meth)acryl-based polymer. And the (meth)acryl-based polymer as the base polymer is preferably a product of emulsion polymerization. A (meth)acryl-based polymer obtained by emulsion polymerization is advantageously used as a base polymer for the aqueous dispersion type pressure-sensitive adhesive.

The invention also relates to a pressure-sensitive adhesive member including a base substrate and the above pressure-sensitive adhesive layer provided on one or both sides of the base substrate. As the pressure-sensitive adhesive member, a pressure-sensitive adhesive optical film using an optical film as the base substrate is preferable.

The invention also relates to a method for manufacturing the above pressure-sensitive adhesive member, including the steps of:

(1) degassing an aqueous dispersion type pressure-sensitive adhesive including a dispersion containing at least a base polymer dispersed in water;

(2) applying the aqueous dispersion type pressure-sensitive adhesive, which has undergone the degassing step (1), to one or both sides of a base substrate; and

(3) drying the applied aqueous dispersion type pressure-sensitive adhesive to form a pressure-sensitive adhesive layer, wherein

the degassing step (1) is performed in a tank of a degassing apparatus,

the aqueous dispersion type pressure-sensitive adhesive is supplied to the applying step (2) using a pump set tank that is connected to the tank of the degassing apparatus through a connecting pipe, and

the aqueous dispersion type pressure-sensitive adhesive having undergone the degassing step (1) is fed from the tank of the degassing apparatus to the pump set tank, while pressures are each set in such a manner that a pressure in the pump set tank and a pressure in the connecting pipe are each 1 kPa to 50 kPa lower than a pressure in the tank of the degassing apparatus.

The invention also relates to a method for manufacturing the above pressure-sensitive adhesive member, comprising the steps of:

(1) degassing an aqueous dispersion type pressure-sensitive adhesive comprising a dispersion containing at least a base polymer dispersed in water;

(2) applying the aqueous dispersion type pressure-sensitive adhesive, which has undergone the degassing step (1), to one or both sides of a base substrate; and

(3) drying the applied aqueous dispersion type pressure-sensitive adhesive to form a pressure-sensitive adhesive layer, wherein

the degassing step (1) is performed in a tank of a degassing apparatus,

the aqueous dispersion type pressure-sensitive adhesive is supplied to the applying step (2) using a pump set tank that is connected to the tank of the degassing apparatus through a buffer tank and a connecting pipe,

the aqueous dispersion type pressure-sensitive adhesive having undergone the degassing step (1) is fed from the tank of the degassing apparatus to the buffer tank, while pressures are each set in such a manner that a pressure in the buffer tank and a pressure in the connecting pipe are each 1 kPa to 50 kPa lower than a pressure in the tank of the degassing apparatus, and the aqueous dispersion type pressure-sensitive adhesive in the buffer tank is fed from the buffer tank to the pump set tank, while pressures are each set in such a manner that a pressure in the pump set tank and a pressure in the connecting pipe are each 1 kPa to 50 kPa lower than a pressure in the buffer tank.

In the manufacturing method, after the degassing step (1) is performed on the aqueous dispersion type pressure-sensitive adhesive, the applying step (2) and then the pressure-sensitive adhesive layer forming step (3) are performed. Air bubbles are previously removed from the aqueous dispersion type pressure-sensitive adhesive in the degassing step (1), and the degassed aqueous dispersion type pressure-sensitive adhesive is fed from the degassing apparatus to the pump set tank under reduced pressure with the aid of a pressure difference produced by pressure reducing means. Therefore, the degassing apparatus, the connecting pipe, and the pump set tank are under reduced pressure, and in the process of feeing the aqueous dispersion type pressure-sensitive adhesive from the degassing apparatus to the pump set tank through the connecting pipe, air is reliably prevented from being mixed in the form of bubbles into or being dissolved in the aqueous dispersion type pressure-sensitive adhesive even when air remains in the system. In addition, even when air bubbles are mixed again into the aqueous dispersion type pressure-sensitive adhesive, they can be easily guided to the gas-liquid interface and easily destroyed. Since the aqueous dispersion type pressure-sensitive adhesive is fed with the aid of a pressure difference, the feed amount of the aqueous dispersion type pressure-sensitive adhesive can be easily controlled. In addition, no pump is necessary for feeding the liquid, so that the properties of the aqueous dispersion type pressure-sensitive adhesive can be prevented from being changed by the effect of the shear or heat of a pump. The pressure difference between the respective tanks is preferably in the range of 1 kPa to 50 kPa, more preferably in the range of 5 kPa to 20 kPa. In the initial state (where no aqueous dispersion type pressure-sensitive adhesive is fed), the pressure difference between the tanks may exceed the above range.

In the method for manufacturing the pressure-sensitive adhesive member, the aqueous dispersion type pressure-sensitive adhesive after the degassing step (1) has a dissolved oxygen concentration that is preferably 10% or less of a dissolved oxygen concentration of the aqueous dispersion type pressure-sensitive adhesive before the degassing step (1).

In the degassing step (1), the dissolved oxygen concentration of the aqueous dispersion type pressure-sensitive adhesive may be controlled to 15% or less of that before the degassing, so that air bubbles produced in the pressure-sensitive adhesive layer can be significantly reduced. The dissolved oxygen concentration is preferably 10% or less, more preferably 8% or less, even more preferably 5% or less of that before the treatment.

In the method for manufacturing the pressure-sensitive adhesive member, the aqueous dispersion type pressure-sensitive adhesive being applied in the applying step (2) preferably has a dissolved oxygen concentration of 3 mg/L or less.

The reduction in the dissolved oxygen concentration of the aqueous dispersion type pressure-sensitive adhesive being used in the applying step (2) enables a significant reduction in the production of air bubbles in the pressure-sensitive adhesive layer. The dissolved oxygen concentration of the aqueous dispersion type pressure-sensitive adhesive being applied is preferably 2 mg/L or less, more preferably 1.5 mg/L or less.

The invention also relates to an image display, including at least one of the above pressure-sensitive adhesive layer or the above pressure-sensitive adhesive member.

### Effects of the Invention

Even when formed using an aqueous dispersion type pressure-sensitive adhesive with a high viscosity, the pressure-sensitive adhesive layer of the invention has a high-quality coating appearance with no problem of fine air bubble defects.

As described above, the pressure-sensitive adhesive layer is formed by a process including performing the degassing step (1) on the aqueous dispersion type pressure-sensitive adhesive, then feeding the degassed aqueous dispersion type pressure-sensitive adhesive from the degassing apparatus to the pump set tank under reduced pressure with the aid of a pressure difference produced by pressure reducing means, then performing the applying step (2), and then performing the pressure-sensitive adhesive layer forming step (3).

Conventionally, there have been proposed various methods and apparatuses for feeding an aqueous dispersion type pressure-sensitive adhesive while the aqueous dispersion type pressure-sensitive adhesive is degassed or defoamed. For example, JP-A No. 2004-249215 discloses a degassing system that is configured to detect, by dissolved oxygen concentration detecting means, the dissolved oxygen concentration of at least one of a coating liquid being fed to a degassing apparatus before degassing and a coating liquid discharged from the degassing apparatus after degassing and to control the degree of degassing in the degassing apparatus by control means for controlling degassing control means based on the result of the detection by the dissolved oxygen concentration detecting means. JP-A No. 2000-262956 discloses a liquid feeing method including reducing the pressure in a liquid feeding system for feeding a coating liquid to a coating head when the feeding of the coating liquid to the coating head is started, then filling the liquid feeding system with a sealing liquid, and then pushing and replacing the sealing liquid by the coating liquid.

In the degassing system or the liquid feeding method disclosed in the patent document, the coating liquid is continuously degassed in line with a degassing apparatus. However, such a technique is applicable only to cases where the coating liquid generally has a low viscosity of less than 100 mPa·s. When the coating liquid has a high viscosity of 100 mPa·s or more, especially, 1,000 mPa·s or more, it is difficult to continuously degassing the coating liquid in line with a degassing apparatus. In such a case, degassing or defoaming is generally performed by a batch method.

When a coating liquid with a high viscosity is degassed or defoamed by a batch method as mentioned above, a large amount of a high-viscosity coating liquid can be degassed or defoamed at a time. However, the degassed or defoamed coating liquid is not used at a time. In such a case, the coating liquid degassed or defoamed as mentioned above is temporarily stored in a storage tank such as a buffer tank, and such a stored coating liquid is fed to a pump set tank or the like by a pump immediately before it is applied, and then it is supplied to a coating head. When a high-viscosity coating liquid is degassed or defoamed by a batch method as mentioned above, it is transferred through a plurality of tanks until it is supplied to the coating head. In addition, since a pump is used to feed the coating liquid, there is a high risk of dissolving air bubbles in the coating liquid.

If air bubbles are dissolved in the coating liquid, air bubbles may remain in a pressure-sensitive adhesive layer formed by the application with the coating head, so that the appearance of the pressure-sensitive adhesive layer may be degraded or the thickness of the pressure-sensitive adhesive layer may vary. After drying, air bubbles may also remain in the pressure-sensitive adhesive layer. To solve this problem, it is necessary to degas or defoam the dissolved air again from the coating liquid and to strictly manage the degassed or defoamed coating liquid. In such a case, excessive degassing or defoaming should be performed, so that significant losses can be produced in the process.

According to the invention, even when degassing or defoaming is performed by a batch method, air bubbles can be reliably prevented from being mixed into or dissolved in the aqueous dispersion type pressure-sensitive adhesive in the process of feeding the pressure-sensitive adhesive, so that the pressure-sensitive adhesive layer can be successfully formed.

### BRIEF DESCRIPTION OF DRAWINGS

FIG. 1 is a schematic diagram illustrating an exemplary system for applying a pressure-sensitive adhesive in a case where a reduced pressure feeding apparatus is used to feed an aqueous dispersion type pressure-sensitive adhesive in the process of manufacturing the pressure-sensitive adhesive member of the invention; and

FIG. 2 is a flow chart illustrating the operation process performed in the pressure-sensitive adhesive applying system.

### EMBODIMENTS FOR CARRYING OUT THE INVENTION

The pressure-sensitive adhesive layer of the invention is formed by applying an aqueous dispersion type pressure-sensitive adhesive and then drying it. The aqueous dispersion type pressure-sensitive adhesive is a dispersion containing a base polymer dispersed in water.

The aqueous dispersion type pressure-sensitive adhesive is an aqueous dispersion as mentioned above, which can be advantageously used even when it has a high viscosity in the range of 100 mPa·s to 10,000 mPa·s. The aqueous dispersion type pressure-sensitive adhesive generally has a solids content of about 1 to about 70% by weight. The aqueous dispersion type pressure-sensitive adhesive having such a high viscosity is suitable for forming a pressure-sensitive adhesive layer. The aqueous dispersion type pressure-sensitive adhesive preferably has a viscosity in the range of 1,000 mPa·s to 5,000 mPa·s. The viscosity of the aqueous dispersion type pressure-sensitive adhesive is the value measured using a viscometer manufactured by HAAKE (RheoStress 1) under the conditions of a temperature of 30° C. and a shear rate of 1 (1/s).

The aqueous dispersion type pressure-sensitive adhesive is a dispersion containing at least a base polymer dispersed in water. While the dispersion to be used generally contains a base polymer dispersed in the presence of a surfactant, a dispersion containing a self-dispersible base polymer dispersed by itself in water may also be used.

The base polymer in the dispersion may be a product obtained by emulsion polymerization or dispersion polymerization of a monomer or monomers in the presence of a surfactant.

The dispersion may also be produced by dispersing and emulsifying a separately produced base polymer in water in the presence of an emulsifying agent. The emulsifying method may be a method including uniformly dispersing and emulsifying a polymer and an emulsifying agent, which may or may not have previously been melted by heating, with water using a mixer such as a pressure kneader, a colloid mill, or a high-speed stirring shaft, under high shearing, and then cooling the mixture in such a manner that the dispersed particles do not fuse or aggregate, so that a desired aqueous dispersion is obtained (high-pressure emulsification method); or a method including previously dissolving a polymer in an organic solvent such as benzene, toluene, or ethyl acetate, then adding the emulsifying agent and water to the solution, uniformly dispersing and emulsifying the mixture typically using a high-speed homogenizer under high shearing, and then removing the organic solvent by a heat treatment under reduced pressure or other methods to form a desired aqueous dispersion (solvent solution method).

The aqueous dispersion type pressure-sensitive adhesive to be used may be of any type such as a rubber-based pressure-sensitive adhesive, an acryl-based pressure-sensitive adhesive, a silicone-based pressure-sensitive adhesive, a urethane-based pressure-sensitive adhesive, a vinyl alkyl ether-based pressure-sensitive adhesive, a polyvinyl alcohol-based pressure-sensitive adhesive, a polyvinylpyrrolidone-based pressure-sensitive adhesive, a polyacrylamide-based pressure-sensitive adhesive, or a cellulose-based pressure-sensitive adhesive. The pressure-sensitive adhesive base polymer or the dispersing means is selected depending on the type of the pressure-sensitive adhesive.

Among the pressure-sensitive adhesives, an aqueous dispersion type acryl-based pressure-sensitive adhesive is preferably used in an embodiment of the invention, because it has a high level of optical transparency and weather resistance or heat resistance and exhibits appropriate wettability and pressure-sensitive adhesive properties such as appropriate cohesiveness and tackiness.

The aqueous dispersion type acryl-based pressure-sensitive adhesive contains a (meth)acryl-based polymer as a base polymer, in which the (meth)acryl-based polymer may be obtained in the form of a copolymer emulsion, which is typically obtained by emulsion polymerization of monomer components containing an alkyl (meth)acrylate ester as a main component in the presence of an emulsifying agent. As used herein, the term “alkyl (meth)acrylate ester” means alkyl acrylate ester and/or alkyl methacrylate ester, and “(meth)” is used in the same meaning in the description.

The alkyl(meth)acrylate ester used to form the main skeleton of the (meth)acryl-based polymer may have a straight or branched chain alkyl group of 1 to 18 carbon atoms. For example, the alkyl group may be methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, octadecyl, or the like. These may be used alone or in any combination. The average carbon number of such alkyl groups is preferably from 3 to 9.

An aromatic ring-containing alkyl(meth)acrylate ester such as phenoxyethyl(meth)acrylate may also be used. A polymer of such an aromatic ring-containing alkyl(meth)acrylate ester may be used in a mixture with any of the exemplary (meth)acryl-based polymers. In view of transparency, however, such an aromatic ring-containing (meth)acrylate ester is preferably used to form a copolymer with the alkyl(meth)acrylate ester.

In order to improve tackiness or heat resistance, one or more copolymerizable monomers having an unsaturated double bond-containing polymerizable functional group such as a (meth)acryloyl group or a vinyl group may be introduced into the (meth)acryl-based polymer by copolymerization. Examples of such copolymerizable monomers include hydroxyl group-containing monomers such as 2-hydroxyethyl(meth)acrylate, 3-hydroxypropyl (meth)acrylate, 4-hydroxybutyl(meth)acrylate, 6-hydroxyhexyl (meth)acrylate, 8-hydroxyoctyl(meth)acrylate, 10-hydroxydecyl (meth)acrylate, 12-hydroxylauryl(meth)acrylate, and (4-hydroxymethylcyclohexyl)-methyl acrylate; carboxyl group-containing monomers such as (meth)acrylic acid, carboxyethyl (meth)acrylate, carboxypentyl(meth)acrylate, itaconic acid, maleic acid, fumaric acid, and crotonic acid; acid anhydride group-containing monomers such as maleic anhydride and itaconic anhydride; caprolactone adducts of acrylic acid; sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth) acryloyloxynaphthalenesulfonic acid; and phosphate group-containing monomers such as 2-hydroxyethylacryloyl phosphate and phosphate esters of polyalkylene oxide (meth)acrylate.

Examples of such monomers for modification also include (N-substituted) amide monomers such as (meth)acrylamide, N,N-dimethyl(meth)acrylamide, N-butyl(meth)acrylamide, N-methylol(meth)acrylamide, N-methylolpropane(meth)acrylamide, and N-hydroxyethyl(meth)acrylamide; alkylaminoalkyl(meth)acrylate monomers such as aminoethyl(meth)acrylate, N,N-dimethylaminoethyl (meth)acrylate, and tert-butylaminoethyl (meth)acrylate; alkoxyalkyl(meth)acrylate monomers such as methoxyethyl(meth)acrylate and ethoxyethyl(meth)acrylate; succinimide monomers such as N-(meth) acryloyloxymethylenesuccinimide, N-(meth)acryloyl-6-oxyhexamethylenesuccinimide, N-(meth)acryloyl-8-oxyoctamethylenesuccinimide, and N-acryloylmorpholine; maleimide monomers such as N-cyclohexylmaleimide, N-isopropylmaleimide, N-laurylmaleimide, and N-phenylmaleimide; and itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide.

Examples of modification monomers that may also be used include vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate monomers such as acrylonitrile and methacrylonitrile; epoxy group-containing acrylic monomers such as glycidyl(meth)acrylate; glycol acrylic ester monomers such as polyethylene glycol (meth)acrylate, polypropylene glycol (meth)acrylate, methoxyethylene glycol (meth)acrylate, and methoxypolypropylene glycol (meth)acrylate; and acrylate ester monomers such as tetrahydrofurfuryl(meth)acrylate, fluoro(meth)acrylate, silicone (meth)acrylate, and 2-methoxyethyl acrylate. Examples also include isoprene, butadiene, isobutylene, and vinyl ether.

Examples of copolymerizable monomers that may also be used include polyfunctional monomers having two or more unsaturated double bonds such as those in (meth)acryloyl groups or vinyl groups, which include (meth)acrylate esters of polyhydric alcohols, such as ethylene glycol di(meth)acrylate, diethylene glycol di(meth)acrylate, tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and compounds having a polyester, epoxy or urethane skeleton to which two or more unsaturated double bonds are added in the form of functional groups such as (meth)acryloyl groups or vinyl groups in the same manner as the monomer component, such as polyester (meth)acrylates, epoxy(meth)acrylates, and urethane (meth)acrylates.

Concerning the weight ratios of all monomer components, the alkyl(meth)acrylate ester should be a main component of the (meth)acryl-based polymer, and the content of the copolymerizable monomer used to form the (meth)acryl-based polymer is preferably, but not limited to, 0 to about 20%, more preferably about 0.1 to about 15%, even more preferably about 0.1 to about 10%, based on the total weight of all monomer components.

Among these copolymerizable monomers, hydroxyl group-containing monomers or carboxyl group-containing monomers are preferably used in view of tackiness or durability. When the aqueous dispersion type pressure-sensitive adhesive contains a crosslinking agent, these copolymerizable monomers can serve as a reactive site with the crosslinking agent. Such hydroxyl group-containing monomers or carboxyl group-containing monomers are highly reactive with intermolecular crosslinking agents and therefore are preferably used to improve the cohesiveness or heat resistance of the resulting pressure-sensitive adhesive layer.

When a hydroxyl group-containing monomer and a carboxyl group-containing monomer are added as copolymerizable monomers, these copolymerizable monomers may each be used in the above ratio. Specifically, a carboxyl group-containing monomer and a hydroxyl group-containing monomer are preferably added in an amount of 0.1 to 10% by weight and in an amount of 0.01 to 2% by weight, respectively. A carboxyl group-containing monomer is more preferably 0.2 to 8% by weight, even more preferably 0.6 to 6% by weight. A hydroxyl group-containing monomer is more preferably 0.03 to 1.5% by weight, even more preferably 0.05 to 1% by weight.

An anionic emulsifying agent or a nonionic emulsifying agent, which has been used in emulsion polymerization, may be used without restriction as the emulsifying agent. Examples include anionic emulsifying agents such as sodium lauryl sulfate, ammonium lauryl sulfate, sodium dodecylbenzenesulfonate, sodium polyoxyethylene alkyl ether sulfate, and sodium polyoxyethylene alkyl phenyl ether sulfate; and nonionic emulsifying agents such as polyoxyethylene alkyl ether and polyoxyethylene alkyl phenyl ether. In both of the cases of the anionic emulsifying agent and the nonionic emulsifying agent, a radically-polymerizable emulsifying agent produced by introducing a reactive functional group such as a propenyl, allyl, or (meth)acryloyl group into an emulsifying agent is preferably used. For example, radically-polymerizable emulsifying agents are disclosed in JP-A Nos. 04-50204 and 04-53802.

The amount of the emulsifying agent to be used is preferably, but not limited to, from about 0.3 to about 5 parts by weight, more preferably from 0.7 to 4 parts by weight, based on 100 parts by weight of monomer components containing the alkyl (meth)acrylate ester as a main component.

The emulsion polymerization of the monomer components may be performed in the presence of the emulsifying agent by a conventional technique using an appropriate polymerization initiator, so that an aqueous dispersion of an acryl-based polymer can be prepared. The emulsion polymerization may be performed according to general batch polymerization, continuous dropping polymerization, intermittent dropping polymerization, or the like. The polymerization may be performed at a temperature of about 30 to about 90° C.

Examples of the polymerization initiator include an azo initiator such as 2,2′-azobisisobutyronitrile, 2,2′-azobis(2-amidinopropane)dihydrochloride, and 2,2′-azobis(N,N′-dimethyleneisobutylamidine), 2,2′-azobis(2-methylpropionamidine)dihydrochloride, or 2,2′-azobis[N-(2-carboxyethyl)-2-methylpropionamidine]hydrate; a persulfate such as potassium persulfate or ammonium persulfate; a peroxide initiator such as benzoyl peroxide or tert-butyl hydroperoxide; and a redox initiator such as a combination of a persulfate and sodium hydrogen sulfite. In the emulsion polymerization, if necessary, an appropriate chain transfer agent such as a mercaptan compound or a mercaptopropionate ester may be used to control the molecular weight of the resulting polymer.

In an embodiment of the invention, the (meth)acryl-based polymer to be used generally has a weight average molecular weight in the range of 1,000,000 to 3,000,000. In view of durability, particularly in view of heat resistance, the (meth)acryl-based polymer to be used preferably has a weight average molecular weight of 1,000,000 to 2,500,000, more preferably 1,700,000 to 2,500,000, even more preferably 1,800,000 to 2,500,000. A weight average molecular weight of less than 1,000,000 is not preferred in view of heat resistance. A weight average molecular weight of more than 3,000,000 is also not preferred, because such a weight average molecular weight may cause a reduction in bonding ability or adhering strength. The weight average molecular weight may refer to a polystyrene-equivalent weight average molecular weight as measured and calculated using GPC (gel permeation chromatography).

The aqueous dispersion type pressure-sensitive adhesive may be used as a radiation-curable pressure-sensitive adhesive. The pressure-sensitive adhesive for use as a radiation-curable pressure-sensitive adhesive can be produced using a radiation-curable base polymer having a radiation-curable functional group such as a (meth)acryloyl group or a vinyl group, or produced by adding a reactive diluent to a base polymer (which may include the radiation-curable base polymer). An example of the radiation-curable pressure-sensitive adhesive also includes a product that contains a monomer or partial polymer thereof, capable of forming a base polymer, and can form a pressure-sensitive adhesive layer containing a base polymer when exposed to a radiation such as an electron beam or ultraviolet light (in this case, the monomer or the partial polymer thereof forms a base polymer). The radiation-curable pressure-sensitive adhesive may contain a polymerization initiator.

The radiation-curable base polymer can be obtained by reaction of a base polymer having a functional group (a) with a compound having a functional group (b) reactive with the functional group (a) and also having a polymerizable carbon-carbon double bond such as a (meth)acryloyl or vinyl group. Examples of the functional group (a) and the functional group (b) include a carboxyl group, an acid anhydride group, a hydroxy group, an amino group, an epoxy group, an isocyanate group, and an aziridine group, and any appropriate combination of the groups reactive with each other may be selected and used. The base polymer of the radiation-curable pressure-sensitive adhesive is also preferably an acryl-based polymer.

The reactive diluent to be used may be a radically-polymerizable monomer component and/or a radically-polymerizable oligomer component having at least one of the above radiation-curable functional groups.

In an embodiment of the invention, the aqueous dispersion type pressure-sensitive adhesive may contain a crosslinking agent in addition to the base polymer (or in addition to the monomer or partial polymer thereof capable of forming a base polymer and the reactive diluent in the case of the radiation-curable type). When the aqueous dispersion type pressure-sensitive adhesive is an aqueous dispersion type acryl-based pressure-sensitive adhesive, the crosslinking agent for use in the adhesive may be a common crosslinking agent such as an isocyanate crosslinking agent, an epoxy crosslinking agent, an oxazoline crosslinking agent, an aziridine crosslinking agent, a carbodiimide crosslinking agent, or a metal chelate crosslinking agent. These crosslinking agents are effective in reacting with and crosslinking the functional group incorporated into the polymer by the use of the functional group-containing monomer.

While the content ratio between the base polymer and the crosslinking agent is not restricted, about 10 parts by weight or less (solid basis) of the crosslinking agent is generally added to 100 parts by weight (solid basis) of the base polymer. The content of the crosslinking agent is preferably from 0.001 to 10 parts by weight, more preferably from 0.01 to 5 parts by weight.

If necessary, the aqueous dispersion type pressure-sensitive adhesive according to an embodiment of the invention may further appropriately contain any of various additives such as tackifiers, plasticizers, fillers including glass fibers, glass beads, metal power, or any other inorganic powder, pigments, colorants, fillers, antioxidants, ultraviolet ray absorbing agents, and silane coupling agents, without departing from the objects of the invention. The aqueous dispersion type pressure-sensitive adhesive may also contain fine particles to form a light-diffusing pressure-sensitive adhesive layer. These additives may also be added in the form of an emulsion.

When the pressure-sensitive adhesive layer of the invention is formed using the aqueous dispersion type pressure-sensitive adhesive, the aqueous dispersion type pressure-sensitive adhesive to be applied is first subjected to the step (1) of performing degassing. Subsequently, the degassing step (1) is followed sequentially by the step (2) of applying, to one or both sides of a base substrate, the aqueous dispersion type pressure-sensitive adhesive having undergone the degassing and by the step (3) of drying the applied aqueous dispersion type pressure-sensitive adhesive to form a pressure-sensitive adhesive layer. In the steps (1) to (3), which may be performed in series, the degassing step (1) is performed in a tank of a degassing apparatus, the aqueous dispersion type pressure-sensitive adhesive is supplied to the applying step (2) using a pump set tank that is connected to the tank of the degassing apparatus through a connecting pipe, and the aqueous dispersion type pressure-sensitive adhesive having undergone the degassing step (1) is fed from the degassing apparatus to the pump set tank with the aid of the difference between the pressures in the respective tanks. The tank of the degassing apparatus may be connected to the pump set tank through a buffer tank and a connecting pipe. Also in this case, the aqueous dispersion type pressure-sensitive adhesive is fed from the degassing apparatus to the pump set tank with the aid of the difference between the pressures in the respective tanks.

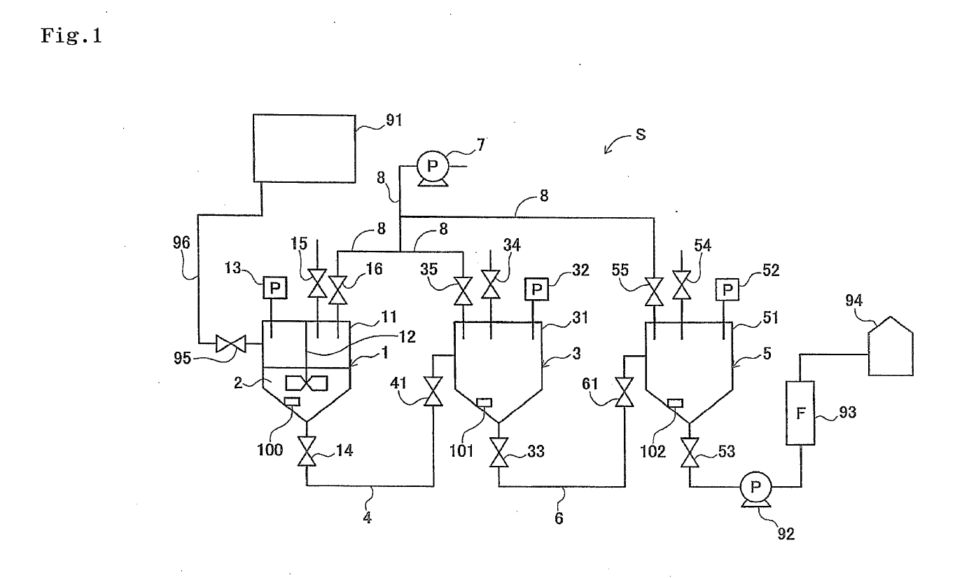

Hereinafter, the step (1) of degassing the aqueous dispersion type pressure-sensitive adhesive and the reduced pressure process of the feeding from the degassing step (1) to the applying step (2) are described with reference to the drawings. FIG. 1 is a schematic diagram showing a system according to an embodiment of the invention for applying the aqueous dispersion type pressure-sensitive adhesive. In this case, a tank of a degassing apparatus is connected to a pump set tank through a buffer tank and a connecting pipe. While FIG. 1 shows a case where a single buffer tank is provided, two or more buffer tanks may be provided alternatively. When two or more buffer tanks are provided, buffer tanks are connected to one another through a connecting pipe or pipes interposed therebetween, and the pressures are each set so that the pressure in the buffer tank for receiving the aqueous dispersion type pressure-sensitive adhesive and the pressure in the connecting pipe are each 1 kPa to 50 kPa lower than the pressure in the buffer tank for feeding the aqueous dispersion type pressure-sensitive adhesive, in which the aqueous dispersion type pressure-sensitive adhesive is fed with the aid of the difference between the pressures in the respective buffer tanks as stated above.

In FIG. 1, a pressure-sensitive adhesive applying system S basically includes a degassing apparatus 1 for degassing an aqueous dispersion type pressure-sensitive adhesive 2 which is placed in a batch type closed tank 11 and contains a pressure-sensitive adhesive; a buffer tank 3 including a closed tank 31 for temporarily storing the aqueous dispersion type pressure-sensitive adhesive 2 having undergone degassing in the close tank 11; a pump set tank 5 including a closed tank 51 for storing the aqueous dispersion type pressure-sensitive adhesive 2 fed from the closed tank 31 of the buffer tank 3 before it is applied; a feed pump 92 for feeing the aqueous dispersion type pressure-sensitive adhesive 2 from the closed tank 51 of the pump set tank 5 to a coating apparatus 94 through a filter 93; and a vacuum pump 7 for reducing the pressure in the closed tank 11 of the degassing apparatus 1, the pressure in the closed tank 31 of the buffer tank 3, the pressure in the closed tank 51 of the pump set tank 5, and so on.

In this system, the closed tank 11 of the degassing apparatus 1 is connected to the closed tank 31 of the buffer tank 3 through a connecting pipe 4, and the connecting pipe 4 has a drain valve 14 at a closed tank 11-side intermediate portion and also has an opening/closing valve 41 at an intermediate portion on the side of the closed tank 31 of the buffer tank 3. The closed tank 31 of the buffer tank 3 is connected to the closed tank 51 of pump set tank 5 through a connecting pipe 6, and the connecting pipe 6 has a drain valve 33 at an intermediate portion on the side of the closed tank 31 of the buffer tank 3 and also has an opening/closing valve 61 at an intermediate portion on the side of the closed tank 51 of the pump set tank 5. A drain valve 53 is also inserted downstream of the pump set tank 5 and connected to a pump 92.

The closed tank 11 of the degassing apparatus 1 is also connected to the vacuum pump 7 through a suction pipe 8 with a vacuum valve 16 interposed therebetween, and the closed tank 31 of the buffer tank 3 is also connected to the vacuum pump 7 through a suction pipe 8 with a vacuum valve 35 interposed therebetween. The closed tank 51 of the pump set tank 5 is also connected to the vacuum pump 7 through a suction pipe 8 with a vacuum valve 55 interposed therebetween.

The degassing apparatus 1 has the closed tank 11, and a stirring blade 12 for stirring the aqueous dispersion type pressure-sensitive adhesive 2 is placed in the closed tank 11. A pressure gauge 13, a leak valve 15, and the vacuum valve 16 inserted in the suction pipe 8 are attached to the upper part of the closed tank 11. The pressure in the closed tank 11 of the degassing apparatus 1 is controlled by controlling the opening of the leak valve 15 and the vacuum valve 16 in the operation. The closed tank 11 of the degassing apparatus 1 is also connected to a charge tank 91 through a connecting pipe 96, in which the charge tank 91 is used to supply the aqueous dispersion type pressure-sensitive adhesive 2 to the closed tank 11. The amount of the aqueous dispersion type pressure-sensitive adhesive 2 being supplied from the charge tank 91 to the closed tank 11 is controlled by controlling the opening/closing of the opening/closing valve 95.

The buffer tank 3 has the closed tank 31, and a pressure gauge 32, a leak valve 34, and the vacuum valve 35 inserted in the suction pipe 8 are attached to the upper part of the closed tank 31. The pressure in the closed tank 31 is controlled by controlling the opening of the leak valve 34 and the vacuum valve 35 in the operation.

The pump set tank 5 has the closed tank 51, and a pressure gauge 52, a leak valve 54, and the vacuum valve 55 inserted in the suction pipe 8 are attached to the upper part of the closed tank 51. The pressure in the closed tank 51 is controlled by controlling the opening of the leak valve 54 and the vacuum valve 55 in the operation.

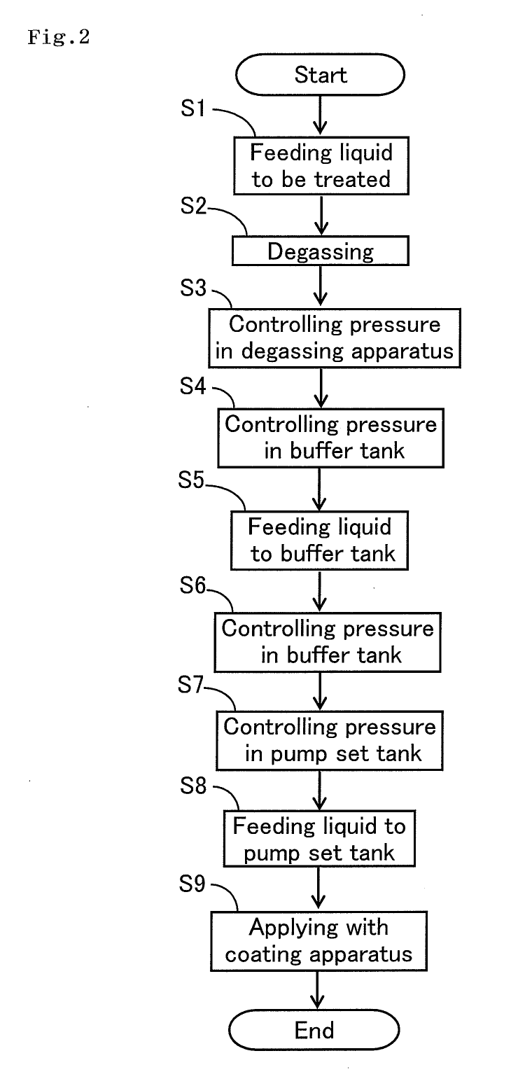

Next, the treatment operation performed in the pressure-sensitive adhesive applying system S configured as described above is described with reference to FIG. 2. FIG. 2 is a flow chart showing the treatment operation performed in the pressure-sensitive adhesive applying system.

First, the aqueous dispersion type pressure-sensitive adhesive 2 is fed from the charge tank 91 into the closed tank 11 for degassing operation 1 by opening the opening/closing valve 95 (S1). Subsequently, the step (1) of degassing the aqueous dispersion type pressure-sensitive adhesive 2 is performed in the degassing apparatus 1 (S2). During the degassing, the vacuum valve 16 is opened, and other valves including the leak valve 15, the opening/closing valve 95, and the drain valve 14 are closed. The pressure in the closed tank 11 is reduced by the vacuum pump 7, and the stirring blade 12 is rotated. Thus, the aqueous dispersion type pressure-sensitive adhesive 2 is degassed. The degassing step (1) may be performed while the pressure in the closed tank 11 for the degassing operation 1 is reduced to about kPa or less, preferably 5 kPa or less, more preferably 2 kPa or less.

After the degassing is completed, the rotation of the stirring blade 12 is stopped, and the opening of the leak valve is controlled so that the pressure in the closed tank 11 is controlled to a predetermined set value (S3). Thereafter, all the valves are closed so that a hermetically sealed system is maintained in the degassing apparatus 1.

Subsequently, the vacuum valve 35 and the opening/closing valve 41 attached to the closed tank 31 of the buffer tank 3 are opened, and the pressures in the closed tank 31 and the connecting pipe 4 are reduced by the vacuum pump 7. In this process, the degree of reduction in pressure is an important factor for regulating the amount of residual air in the liquid supply system so that contamination of the aqueous dispersion type pressure-sensitive adhesive 2 with air bubbles can be prevented. In an embodiment of the invention, the absolute pressure in the reduced-pressure feed system should be 50 kPa or less, preferably 20 kPa or less, more preferably 7 kPa or less. If air is present in a liquid supply path, a gas-liquid interface will be formed at that plate, so that the risk of incorporating air bubbles into the aqueous dispersion type pressure-sensitive adhesive 2 will be increased by the transfer of the aqueous dispersion type pressure-sensitive adhesive 2. Therefore, it is necessary to reduce the pressure in the liquid supply system as described above. In addition, since the saturated vapor pressure varies with the nature of the aqueous dispersion type pressure-sensitive adhesive 2, the pressure in the liquid supply system should also be set depending on the temperature during the liquid supply so that the aqueous dispersion type pressure-sensitive adhesive 2 can be prevented from boiling.

The opening of the leak valve 34 is controlled by the operation so that the pressures in the closed tank 31 and the connecting pipe 4 are controlled to predetermined set values (S4). In this controlled state, the drain valve 14, which is inserted in the connecting pipe 4 and placed downstream of the closed tank 11, is opened. At this time, a pressure difference is produced between the closed tank 11 of the degassing apparatus 1 and the closed tank 31 of the buffer tank 3 and the connecting pipe 4, and based on the pressure difference, the feeding of the aqueous dispersion type pressure-sensitive adhesive 2 from the closed tank 11 to the closed tank 31 is started (S5). When the aqueous dispersion type pressure-sensitive adhesive 2 is fed based on the pressure difference as described above, the pressure difference between the upstream and downstream parts of the liquid supply is an important factor for controlling the liquid flow rate. In an embodiment of the invention, for example, the pressure difference is preferably in the range of 1 kPa to 50 kPa, more preferably in the range of 5 kPa to 20 kPa. If the pressure difference is too large, the liquid flow rate will increase so that the gas-liquid interface can rapidly fluctuate to trap air bubbles easily. In this embodiment, if the pressure difference is more than 50 kPa, the aqueous dispersion type pressure-sensitive adhesive 2 may be often contaminated with air bubbles, and if the pressure difference is less than 1 kPa, the liquid flow rate may be too low to be suitable for production.

During the feeding of the aqueous dispersion type pressure-sensitive adhesive 2, the opening of the leak valve 15 on the degassing apparatus 1 side and the opening of the leak valve 34 on the buffer tank 3 side are controlled so that the pressure in the closed tank 11 of the degassing apparatus 1 and the pressure in the closed tank 31 of the buffer tank 3 are each controlled to a predetermined set value (S6). In this process, the drain valve 14 and the opening/closing valve 41 are closed before the aqueous dispersion type pressure-sensitive adhesive 2 is completely discharged from the closed tank 11. This prevents contamination of the aqueous dispersion type pressure-sensitive adhesive 2 with air bubbles, which would otherwise be caused by air flow generated when the discharge of the aqueous dispersion type pressure-sensitive adhesive 2 is completed.

In this process, when the aqueous dispersion type pressure-sensitive adhesive 2 is fed into and stored in the closed tank 31 of the buffer tank 3, the tank 31 may be an open or closed system. Even when a closed system is formed, the pressure in the closed tank 31 of the buffer tank 3 may be a reduced pressure or the atmospheric pressure. When the closed tank 31 is kept at a reduced pressure, stationary degassing can be facilitated.

Subsequently, the vacuum valve 55 and the opening/closing valve 61 of the closed tank 51 of the pump set tank 5 are opened so that the pressures in the closed tank 51 and the connecting pipe 6 are reduced by the vacuum pump 7. The opening of the leak valve 54 is also controlled by the operation so that the pressures in the closed tank 51 and the connecting pipe 6 are controlled to predetermined set values (S7). In this controlled state, the drain valve 33 inserted in the connecting pipe 6 and placed downstream of the closed tank 31 is opened. In this process, a pressure difference is produced between the closed tank 31 and the closed tank 51 and the connecting pipe 6, and based on the pressure difference, the feeding of the aqueous dispersion type pressure-sensitive adhesive 2 from the closed tank 31 to the closed tank 51 is started (S8). In this case, the pressure difference between the upstream and downstream parts of the liquid supply is preferably in the range of 1 kPa to 50 kPa, more preferably in the range of 5 kPa to 20 kPa, as described above.

During the feeding of the aqueous dispersion type pressure-sensitive adhesive 2, the opening of the leak valve 34 on the buffer tank 3 side and the opening of the leak valve 54 on the pump set tank 5 side are controlled so that the pressure in the closed tank 31 of the buffer tank 3 and the pressure in the closed tank 51 of the pump set tank 5 are each controlled to a predetermined set value. In this process, the drain valve 33 and the opening/closing valve 61 are closed before the aqueous dispersion type pressure-sensitive adhesive 2 is completely discharged from the closed tank 31. This prevents contamination of the aqueous dispersion type pressure-sensitive adhesive 2 with air bubbles, which would otherwise be caused by air flow generated when the discharge of the aqueous dispersion type pressure-sensitive adhesive 2 is completed.

After the aqueous dispersion type pressure-sensitive adhesive 2 is fed to the closed tank 51 of the pump set tank 5 as described above, the drain valve 53 is opened, and the feed pump 92 is driven. Therefore, the aqueous dispersion type pressure-sensitive adhesive 2 is fed from the feed pump 92 to the coating apparatus 94 through the filter 93. The coating apparatus 94 performs the step (2) of applying the aqueous dispersion type pressure-sensitive adhesive to one or both sides of a base substrate and then the step (3) of drying the applied aqueous dispersion type pressure-sensitive adhesive to form a pressure-sensitive adhesive layer (S9). The feeding of the aqueous dispersion type pressure-sensitive adhesive 2 to the coating apparatus 94 is preferably performed after a process that includes first allowing water to flow through the filter 93 to remove air bubbles from the filter 93 and circulating the aqueous dispersion type pressure-sensitive adhesive 2 through the closed tank 51 for about 1 to 3 hours to replace water in the filter 93 with the aqueous dispersion type pressure-sensitive adhesive 2. Although not illustrated in FIG. 1, the circulation of the aqueous dispersion type pressure-sensitive adhesive 2 can be achieved using a system that includes: a valve provided in the liquid supply pipe connecting the filter 93 to the coating apparatus 94; and a circulation pipe branched from the liquid supply pipe and connected to the closed tank 51, in which the valve is opened and closed for circulation, or using a system that includes a detachable liquid supply pipe directly connected to the closed tank 51.

It will be understood that the operation of the vacuum pump 7 and different valves in the system may be manually performed while the indications of the pressure gauges 13, 32, and 52 are each checked, or automatically performed by remote control based on the indication of each of the pressure gauges 13, 32, and 52. The vacuum pump 7 may be a single pump or a set of plural pumps.

Next, a description is given of the measurement of the concentration of dissolved oxygen in the aqueous dispersion type pressure-sensitive adhesive 2 from the time before the aqueous dispersion type pressure-sensitive adhesive 2 is degassed to the time when the adhesive 2 is applied. Attention should be paid on the concentration of dissolved oxygen in the aqueous dispersion type pressure-sensitive adhesive 2, because if air is dissolved in the aqueous dispersion type pressure-sensitive adhesive 2, the air may form air bubbles during the drying of the aqueous dispersion type pressure-sensitive adhesive 2 so that various problems may occur due to the air bubbles, and therefore, the concentration of dissolved oxygen in the aqueous dispersion type pressure-sensitive adhesive 2 should be strictly controlled during the period from the degassing to the application. When the amount of dissolved air in the aqueous dispersion type pressure-sensitive adhesive 2 is determined, the concentration of dissolved oxygen is generally used to indicate the amount of dissolved air in the aqueous dispersion type pressure-sensitive adhesive 2.

The concentration of dissolved oxygen in the aqueous dispersion type pressure-sensitive adhesive 2 is measured before the degassing step (1) is performed in the degassing apparatus 1 (before degassing), after the degassing is performed (after degassing), and after the feeding to the closed tank 31 of the buffer tank 3 (after feeding). The concentration of dissolved oxygen in the aqueous dispersion type pressure-sensitive adhesive 2 to be applied is also measured before the applying step (2). In an embodiment of the invention, the concentration of dissolved oxygen in the aqueous dispersion type pressure-sensitive adhesive 2 is specifically measured as described in Examples.

As shown in FIG. 1, a dissolved oxygen meter 100 is placed at the bottom of the closed tank 11 of the degassing apparatus 1. Using the dissolved oxygen meter 100, the concentration of dissolved oxygen in the aqueous dispersion type pressure-sensitive adhesive 2 can be measured before the aqueous dispersion type pressure-sensitive adhesive 2 placed in the closed tank 11 is degassed and after the aqueous dispersion type pressure-sensitive adhesive 2 is degassed. Alternatively, a sample of the aqueous dispersion type pressure-sensitive adhesive 2 may be taken out of the system before and after the degassing, and the concentration of dissolved oxygen in each sample may be measured using a meter.

As shown in FIG. 1, a dissolved oxygen meter 101 is also placed at the bottom of the closed tank 31 of the buffer tank 3. Using the dissolved oxygen meter 101, the concentration of dissolved oxygen in the aqueous dispersion type pressure-sensitive adhesive 2 can be measured after the aqueous dispersion type pressure-sensitive adhesive 2 is fed to the buffer tank 3. As mentioned above, a sample of the aqueous dispersion type pressure-sensitive adhesive 2 may also be taken out of the system, and the concentration of dissolved oxygen in the sample may be measured using a meter.

As shown in FIG. 1, a dissolved oxygen meter 102 is further placed at the bottom of the closed tank 51 of the pump set tank 5. Using the dissolved oxygen meter 102, the concentration of dissolved oxygen in the aqueous dispersion type pressure-sensitive adhesive 2 before the applying step (2) can be measured before and after it is circulated through the filter. In addition, two or more samples of the aqueous dispersion type pressure-sensitive adhesive may be extracted before the applying step (2) and each subjected to the measurement of the concentration of dissolved oxygen, and the final concentration of dissolved oxygen in the aqueous dispersion type pressure-sensitive adhesive may be measured after the applying step (2).

Next, a description is given of the applying step (2) and the pressure-sensitive adhesive layer forming step (3). By these steps, a pressure-sensitive adhesive layer is formed on a base substrate. The base substrate to be used may be any of various materials, examples of which include an optical film, a surface protecting film substrate, and a separator.

When the base substrate is a separator, the pressure-sensitive adhesive member is typically obtained by applying the aqueous dispersion type pressure-sensitive adhesive to the separator and drying the adhesive to form a pressure-sensitive adhesive layer. When the base substrate is an optical film or the like, the pressure-sensitive adhesive member is produced by a method including forming a pressure-sensitive adhesive layer on the separator and transferring the pressure-sensitive adhesive layer onto the optical film or the like or by a method including applying the aqueous dispersion type pressure-sensitive adhesive to the optical film or the like and drying the adhesive to form a pressure-sensitive adhesive layer on the optical film or the like directly.

The applying step (2) may be performed using any of various methods. Examples include roll coating, kiss roll coating, gravure coating, reverse coating, roll brushing, spray coating, dip roll coating, bar coating, knife coating, air knife coating, curtain coating, lip coating, and extrusion coating with a die coater or the like.

The pressure-sensitive adhesive layer forming step (3) may be performed under normal conditions for using the aqueous dispersion type pressure-sensitive adhesive, specifically, at a drying temperature of, for example, 40 to 150° C. for a drying time of 20 seconds to 30 minutes.

The thickness of the pressure-sensitive adhesive layer is typically, but not limited to, from about 1 to about 100 μm, preferably from 5 to 50 μm, more preferably from 10 to 30 μm.

The pressure-sensitive adhesive layer preferably has a total light transmittance of 10% or more and a haze of 75% or less in the visible light wavelength region as measured by the method described below.

The pressure-sensitive adhesive layer having a total light transmittance of 10% or more or a haze of 75% or less as measured by the method below is in such a state that an appearance defect caused by air bubbles can be easily identified. Also in optical applications, a high total light transmittance and a low haze are preferred. The total light transmittance is preferably 14% or more, more preferably 18% or more. The haze is preferably 65% or less.

### <Total Light Transmittance and Haze in Visible Light Wavelength Region>

A 100 μm thick polarizing plate (TEG-DU manufactured by NITTO DENKO CORPORATION) was bonded to one side of the pressure-sensitive adhesive layer (23 μm in thickness) to be measured, and the resulting laminate (a layered structure of the polarizing plate/the pressure-sensitive adhesive layer) was measured for total light transmittance (%) according to JIS K 7361 and for haze (%) according to JIS K 7136 using HAZE METER MODEL HM-150 (manufactured by MURAKAMI COLOR RESEARCH LABORATORY CO., Ltd.).

Examples of the material used to form the separator include a plastic film such as a polyethylene, polypropylene, polyethylene terephthalate, or polyester film, a porous material such as paper, fabric, or nonwoven fabric, and an appropriate thin material such as a net, a foamed sheet, a metal foil, and a laminate thereof. A plastic film is preferably used, because of its good surface smoothness.

Any plastic film capable of protecting the pressure-sensitive adhesive layer may be used, examples of which include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the separator is generally from about 5 to about 200 μm, preferably from about 5 to about 100 μm. If necessary, the separator may be subjected to a release treatment and an antifouling treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the separator is appropriately subjected to a release treatment such as a silicone treatment, a long-chain alkyl treatment, or a fluorine treatment, the releasability from the pressure-sensitive adhesive layer can be further increased.

The pressure-sensitive adhesive layer may be exposed. In such a case, the pressure-sensitive adhesive layer may be protected by the separator until it is actually used. The release-treated sheet used in the preparation of the pressure-sensitive adhesive member may be used as is as a separator for a pressure-sensitive adhesive optical film, so that the process can be simplified.

When the base substrate is a surface protecting film substrate or an optical film may also be coated with an anchor layer or subjected to any adhesion-facilitating treatment such as a corona treatment or a plasma treatment so as to have improved adhesion to a pressure-sensitive adhesive layer, and then the pressure-sensitive adhesive layer may be formed. The surface of the pressure-sensitive adhesive layer may also be subjected to an adhesion-facilitating treatment.

Materials that may be used to form the anchor layer preferably include an anchoring agent selected from polyurethane, polyester, and polymers containing an amino group in the molecule, in particular, preferably polymers containing an amino group in the molecule. Polymers containing an amino group in the molecule allow the amino group in the molecule to react with a carboxyl group or the like in the pressure-sensitive adhesive or to make an interaction such as an ionic interaction, so that good adhesion can be ensured.

Examples of polymers containing an amino group in the molecule include polyethyleneimine, polyallylamine, polyvinylamine, polyvinylpyridine, polyvinylpyrrolidine, and a polymer of an amino group-containing monomer such as dimethylaminoethyl acrylate.

Examples of a plastic film for use in the surface protecting film substrate may be the same as the materials for the separator. The surface of the plastic film may be roughened or coated with a release treatment layer as needed.

The optical film is, but not limited to the kinds, used for forming image display such as liquid crystal display. A polarizing plate is exemplified. A polarizing plate including a polarizer and a transparent protective film provided on one side or both sides of the polarizer is generally used.

A polarizer is, but not limited to, various kinds of polarizer may be used. As a polarizer, for example, a film that is uniaxially stretched after having dichromatic substances, such as iodine and dichromatic dye, absorbed to hydrophilic polymer films, such as polyvinyl alcohol-based film, partially formalized polyvinyl alcohol-based film, and ethylene-vinyl acetate copolymer-based partially saponified film; polyene-based alignment films, such as dehydrated polyvinyl alcohol and dehydrochlorinated polyvinyl chloride, etc. may be mentioned. In these, a polyvinyl alcohol-based film on which dichromatic materials such as iodine, is absorbed and aligned after stretched is suitably used. Thickness of polarizer is, but not limited to, generally about 5 to about 80 μm.

A polarizer that is uniaxially stretched after a polyvinyl alcohol-based film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol-based film may be dipped in water and rinsed if needed. By rinsing polyvinyl alcohol-based film with water, effect of preventing un-uniformity, such as unevenness of dyeing, is expected by making polyvinyl alcohol-based film swelled in addition that also soils and blocking inhibitors on the polyvinyl alcohol-based film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

An optical film of the invention may be exemplified as other optical layers, such as a reflective plate, a transflective plate, a retardation plate (a half wavelength plate and a quarter wavelength plate included), and a viewing angle compensation film, which may be used for formation of a liquid crystal display etc. These are used in practice as an optical film, or as one layer or two layers or more of optical layers laminated with polarizing plate.

Although an optical film with the above described optical layer laminated to the polarizing plate may be formed by a method in which laminating is separately carried out sequentially in manufacturing process of a liquid crystal display or the like, an optical film in a form of being laminated beforehand has an outstanding advantage that it has excellent stability in quality and assembly workability, and thus manufacturing processes ability of a liquid crystal display or the like may be raised. Proper adhesion means, such as a pressure-sensitive adhesive layer, may be used for laminating. On the occasion of adhesion of the above described polarizing plate and other optical films, the optical axis may be set as a suitable configuration angle according to the target retardation characteristics or the like.

The pressure-sensitive adhesive optical film of the invention is preferably used to form various types of image displays such as liquid crystal displays. Liquid crystal displays may be produced according to conventional techniques. Specifically, liquid crystal displays are generally produced by appropriately assembling a display panel such as a liquid crystal cell and the pressure-sensitive adhesive optical film and optionally other components such as a lighting system and incorporating a driving circuit according to any conventional technique, except that the pressure-sensitive adhesive optical film of the invention is used. Any type of liquid crystal cell may also be used such as a TN type, an STN type, a n type, a VA type and an IPS type.

Suitable liquid crystal displays, such as liquid crystal display with which the above pressure-sensitive adhesive optical film has been provided on one side or both sides of the display panel such as a liquid crystal cell, and with which a backlight or a reflective plate is used for a lighting system may be manufactured. In this case, the pressure-sensitive adhesive optical film may be provided on one side or both sides of the display panel such as a liquid crystal cell. When providing the pressure-sensitive adhesive optical films on both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

### EXAMPLES

Hereinafter, the invention is more specifically described with reference to the Examples, which however are not intended to limit the invention. Unless otherwise stated, “parts” and “%” in each example are all by weight.

### Example 1

### Preparation of Pre-Emulsion

To a vessel were added 92 parts of butyl acrylate, 6 parts of methacrylic acid, 2 parts of mono[poly(propylene oxide) methacrylate]phosphate ester (with an average degree of polymerization of propylene oxide of about 5.0), and 0.03 parts of 3-methacryloyloxypropyl-trimethoxysilane (KBM-503 manufactured by Shin-Etsu Chemical Co., Ltd.) and mixed to form a mixture of reactive components. Subsequently, 46.6 g of a reactive emulsifying agent AQUALON HS-10 (manufactured by DAI-ICHI KOGYO SEIYAKU CO., LTD.) and 346 g of ion-exchanged water were added to 388 g of the prepared mixture of reactive components and stirred and forcedly emulsified at 5,000 (1/minute) for 5 minutes using a homogenizer (manufactured by PRIMIX Corporation) to form a monomer pre-emulsion.

### (Preparation of Emulsion Solution of Water Dispersible Copolymer)

To a reaction vessel equipped with a condenser tube, a nitrogen introducing tube, a thermometer, and a stirrer were added 156 g part of the prepared monomer pre-emulsion and 219 g of ion-exchanged water. Subsequently, the air in the reaction vessel was replaced with nitrogen, and 0.023 g of ammonium persulfate (0.03 parts based on 100 parts of the solid of the monomer pre-emulsion added) was added. The mixture was subjected to polymerization at 65° C. for 2.5 hours. Subsequently, 0.217 g of ammonium persulfate (0.07 parts based on 100 parts of the solid of the remaining monomer pre-emulsion) was added to 625 g of the remaining monomer pre-emulsion, and the resulting mixture was added dropwise to the reaction vessel over 3 hours. Subsequently, while nitrogen gas replacement was performed, polymerization was performed at 70° C. for 3 hours, so that an emulsion solution of a water dispersible copolymer was obtained with a solid content of 40%.

### (Preparation of Aqueous Dispersion Type Pressure-Sensitive Adhesive Composition)

The resulting emulsion solution of the water dispersible copolymer was cooled to room temperature, and 10% ammonia water was added to adjust the pH to 8. A carbodiimide crosslinking agent (CARBODILITE V-04, water-soluble type, manufactured by Nisshinbo Chemical Inc.) was further added in an amount of 0.1 parts based on 100 parts of the solid of the water dispersible copolymer, so that an aqueous dispersion type pressure-sensitive adhesive composition (6000 mPa·s in viscosity) was prepared.

### (Degassing of the Aqueous Dispersion Type Pressure-Sensitive Adhesive)

According to FIG. 1, operation was performed as described below. First, the aqueous dispersion type pressure-sensitive adhesive 2 (80 kg) was fed into the closed tank 11 of the degassing apparatus 1. In this state, the aqueous dispersion type pressure-sensitive adhesive 2 was sampled and measured for dissolved oxygen concentration using a dissolved oxygen concentration meter before degassing. As a result, the dissolved oxygen concentration was 5.75 mg/L.

The aqueous dispersion type pressure-sensitive adhesive 2 placed in the closed tank 11 was degassed for 30 minutes. During the degassing, the vacuum valve 16 was opened, and the other valves connected to the degassing apparatus 1 were all closed. The internal pressure of the closed tank 11 was set at 3 kPa and the stirring blade 12 was rotated, when the degassing was performed under reduced pressure. After the degassing, the aqueous dispersion type pressure-sensitive adhesive 2 was sampled and measured for dissolved oxygen concentration after the degassing using a dissolved oxygen concentration meter. As a result, the dissolved oxygen concentration was 0.41 mg/L. The dissolved oxygen concentration (0.41 mg/L) after the degassing was 7.13% of that (5.75 mg/L) before the degassing, which means that the dissolved oxygen concentration was reduced to at most 10% of that before the degassing. The dissolved oxygen concentration of the aqueous dispersion type pressure-sensitive adhesive 2 before the degassing was the measured value of a sample taken from the connecting pipe 96 between the opening/closing valve 95 and the closed tank 11, and the dissolved oxygen concentration of the aqueous dispersion type pressure-sensitive adhesive 2 after the degassing was the measured value of a sample taken out immediately after it passed through the drain valve 14.

The dissolved oxygen concentration was measured by a process including placing the sample (about 150 ml) of the aqueous dispersion type pressure-sensitive adhesive in a 200 ml wide-mouthed glass bottle, placing therein the electrode of the dissolved oxygen concentration meter (Dissolved Oxygen Meter/model, Thermo Electron Co.), and measuring the dissolved oxygen concentration under gentle stirring. The measurement was performed at a temperature of 26° C. The dissolved oxygen concentrations of other samples were also measured in the same manner.

### (Feeding of the Aqueous Dispersion Type Pressure-Sensitive Adhesive Under Reduced Pressure)

Subsequently, the opening of the leak valve 15 of the degassing apparatus 1, the opening of the vacuum valve 16, the opening of the leak valve 34 of the buffer tank 3, and the opening of the vacuum valve 35 were controlled by the operation. Using the vacuum pump 7, the internal pressure of the closed tank 11 of the degassing apparatus 1 was set to 11 kPa, and the internal pressure of the closed tank 31 of the buffer tank 3 was reduced and controlled to 4 kPa.

Subsequently, the drain valve 14 and the opening/closing valve 41 were opened, and the aqueous dispersion type pressure-sensitive adhesive 2 was fed from the closed tank 11 of the degassing apparatus 1 to the closed tank 31 of the buffer tank 3 based on the pressure difference between the closed tanks 11 and 31. At this time, the opening of the leak valve 15 was controlled by the operation based on the indication of the pressure gauge 13, in which the internal pressure of the closed tank 11 of the degassing apparatus 1 was controlled to 11 kPa until the connecting pipe 4 was filled with the aqueous dispersion type pressure-sensitive adhesive 2, and the internal pressure of the closed tank 11 of the degassing apparatus 1 was controlled to 17 kPa after the aqueous dispersion type pressure-sensitive adhesive 2 began flowing into the closed tank 31 of the buffer tank 3. Specifically, the leak valve 15 was controlled by the operation so that there was a difference of 13 kPa or less between the internal pressure of the closed tank 11 of the degassing apparatus 1 and the internal pressure of the closed tank 31 of the buffer tank 3.

After the aqueous dispersion type pressure-sensitive adhesive 2 was fed to the closed tank 31 side of the buffer tank 3, all valves connected to the buffer tank 3 were closed. At this time, the aqueous dispersion type pressure-sensitive adhesive 2 was sampled and measured for dissolved oxygen concentration after the feeding using a dissolved oxygen concentration meter. As a result, the dissolved oxygen concentration was 0.28 mg/L. The dissolved oxygen concentration (0.28 mg/L) after the feeding of the aqueous dispersion type pressure-sensitive adhesive 2 to the closed tank 31 was 4.87% of the dissolved oxygen concentration (5.75 mg/L) before the degassing, which means that as compared with immediately after the degassing, the dissolved oxygen concentration was further reduced to at most 5% of that before the degassing. The dissolved oxygen concentration of the aqueous dispersion type pressure-sensitive adhesive 2 was the measured value of a sample taken out immediately after it passed through the drain valve 33.

Subsequently, the opening of the leak valve 34 of the buffer tank 3, the opening of the vacuum valve 35, the opening of the leak valve 54 of the pump set tank 5, and the opening of the vacuum valve 55 were controlled by the operation. Using the vacuum pump 7, the internal pressure of the closed tank 31 of the buffer tank 3 was set to 11 kPa, and the internal pressure of the closed tank 51 of the pump set tank 5 was reduced to 4 kPa by the operation.

Subsequently, the drain valve 33 and the opening/closing valve 61 were opened, and based on the pressure difference between the closed tank 31 of the buffer tank 3 and the closed tank 51 of the pump set tank 5, the aqueous dispersion type pressure-sensitive adhesive 2 was fed from the closed tank 31 of the buffer tank 3 to the closed tank 51 of the pump set tank 5. At this time, the opening of the leak valve 34 was controlled by the operation based on the indication of the pressure gauge 32, in which the internal pressure of the closed tank 31 of the buffer tank 3 was set at 11 kPa until the connecting pipe 6 was filled with the aqueous dispersion type pressure-sensitive adhesive 2, and the internal pressure of the closed tank 31 of the buffer tank 3 was controlled to 23 kPa after the aqueous dispersion type pressure-sensitive adhesive 2 began flowing into the closed tank 51 of the pump set tank 5. Specifically, the leak valve 54 was controlled by the operation so that there was a difference of 19 kPa or less between the internal pressure of the closed tank 31 of the buffer tank 3 and the internal pressure of the closed tank 51 of the pump set tank 5.

After the aqueous dispersion type pressure-sensitive adhesive 2 was fed to the closed tank 51 of the pump set tank 5, all valves connected to the pump set tank 5 were closed. At this time, the aqueous dispersion type pressure-sensitive adhesive 2 was sampled and measured for dissolved oxygen concentration after the feeding using a dissolved oxygen concentration meter. As a result, the dissolved oxygen concentration was 0.28 mg/L. The dissolved oxygen concentration (0.28 mg/L) after the feeding of the aqueous dispersion type pressure-sensitive adhesive 2 to the closed tank 51 was 4.87% of the dissolved oxygen concentration (5.75 mg/L) before the degassing, which means that the dissolved oxygen concentration was maintained at the level after the feeding to the closed tank 31 and that as compared with immediately after the degassing, the dissolved oxygen concentration was further reduced to at most 5% of that before the degassing. The dissolved oxygen concentration of the aqueous dispersion type pressure-sensitive adhesive 2 was the measured value of a sample taken out immediately after it passed through the drain valve 53.

Thereafter, the aqueous dispersion type pressure-sensitive adhesive 2 was fed by the feed pump 92 from the closed tank 51 of the pump set tank 5 to the coating apparatus 94 through the filter 93, when a pressure-sensitive adhesive layer was formed as described below. Water was first allowed to flow through the filter 93 so that air bubbles were removed from the filter 93. Subsequently, the aqueous dispersion type pressure-sensitive adhesive 2 was allowed to flow so that the water was pushed out of the filter 93 by the aqueous dispersion type pressure-sensitive adhesive 2. Thereafter, the aqueous dispersion type pressure-sensitive adhesive 2 was circulated through the closed tank 51 for 1 hour so that the water in the filter 93 was replaced with the aqueous dispersion type pressure-sensitive adhesive 2. The dissolved oxygen concentration was 0.83 mg/L and 0.66 mg/L before and after the replacement of water, respectively. The dissolved oxygen concentration of the aqueous dispersion type pressure-sensitive adhesive 2 was the measured value of a sample taken from a portion upstream of the coating apparatus 94 immediately after it passed through the drain valve 53.

### (Formation of Pressure-Sensitive Adhesive Layer)

The aqueous dispersion type pressure-sensitive adhesive 2 being fed as described above was applied to the surface of a separator, which was made of a release-treated polyethylene terephthalate film (38 μm in thickness), using a die coater in such a manner that the coating could have a thickness of 23 μm after drying, and subsequently, the coating was dried at 100° C. for 135 seconds to form a pressure-sensitive adhesive layer. The aqueous dispersion type pressure-sensitive adhesive 2 to be applied had a dissolved oxygen concentration of 0.55 mg/L. Immediately before the application, the aqueous dispersion type pressure-sensitive adhesive 2 was sampled upstream of the coating apparatus 94 (at a portion immediately upstream of the coater) and measured for dissolved oxygen concentration. At the time of completion of the application, the aqueous dispersion type pressure-sensitive adhesive 2 remaining upstream of the coating apparatus 94 (at a portion immediately upstream of the coater) had a final dissolved oxygen concentration of 1.04 mg/L.

### Example 2

### Preparation of Aqueous Dispersion Type Pressure-Sensitive Adhesive

To a reaction vessel equipped with a condenser tube, a nitrogen introducing tube, a thermometer, and a stirrer were added 30 parts of water and 0.3 parts of ammonium persulfate, and the air in the vessel was replaced with nitrogen for 1 hour under stirring. An emulsion was obtained by emulsifying 95 parts of 2-ethylhexyl acrylate, 5 parts of acrylic acid, and 1.0 part (solid basis) of ammonium polyoxyethylene lauryl ether sulfate (HITENOL LA-16 (trade name) manufactured by DAI-ICHI KOGYO SEIYAKU CO., LTD.) as an emulsifying agent with 70 parts of water. The resulting emulsion was added dropwise to the reaction vessel at 80° C. over 3 hours, and the reaction mixture was further aged at 80° C. for 2 hours. Subsequently, the reaction mixture was cooled to room temperature and adjusted to pH 8 with 10% by weight ammonia water to give a copolymer emulsion. Into the copolymer emulsion was mixed 0.1 parts (solid basis) of an oxazoline group-containing water-soluble crosslinking agent (EPOCROS WS-700 (trade name) manufactured by NIPPON SHOKUBAI CO., LTD., 220 g·solid/eq. (oxazoline group equivalent)) based on 100 parts of the solid (water dispersible copolymer) of the copolymer emulsion, so that an aqueous dispersion type pressure-sensitive adhesive (with a base polymer solid content of 39% and a viscosity of 6,000 mPa·s) was prepared.

### (Degassing of the Aqueous Dispersion Type Pressure-Sensitive Adhesive)

The same operation was performed as in Example 1, except that the resulting aqueous dispersion type pressure-sensitive adhesive was used instead. Before the degassing, the aqueous dispersion type pressure-sensitive adhesive had a dissolved oxygen concentration of 4.88 mg/L. After the degassing, the dissolved oxygen concentration was 0.32 mg/L, which was 6.56% of the dissolved oxygen concentration (4.88 mg/L) before the degassing.

### (Feeding of the Aqueous Dispersion Type Pressure-Sensitive Adhesive Under Reduced Pressure)

The same operation was performed as in Example 1, except that the resulting aqueous dispersion type pressure-sensitive adhesive was used instead. After the feeding to the buffer tank, the dissolved oxygen concentration was determined to be 0.15 mg/L. The dissolved oxygen concentration (0.15 mg/L) after the feeding to the buffer tank was 3.07% of the dissolved oxygen concentration (4.88 mg/L) before the degassing.

After the feeding to the pump set tank, the dissolved oxygen concentration was determined to be 0.15 mg/L. The dissolved oxygen concentration (0.15 mg/L) after the feeding to the pump set tank was 3.07% of that (4.88 mg/L) before the degassing.

### (Formation of Pressure-Sensitive Adhesive Layer)

Subsequently, in the same manner as in Example 1, the aqueous dispersion type pressure-sensitive adhesive being fed was applied to the surface of a separator, which was made of a release-treated polyethylene terephthalate film (38 μm in thickness), using a die coater in such a manner that the coating could have a thickness of 23 μm after drying, and then the coating was dried at 100° C. for 135 seconds to form a pressure-sensitive adhesive layer. The aqueous dispersion type pressure-sensitive adhesive to be applied had a dissolved oxygen concentration of 0.80 mg/L. At the time of completion of the application, the aqueous dispersion type pressure-sensitive adhesive had a final dissolved oxygen concentration of 0.86 mg/L.

### Comparative Example 1

A pressure-sensitive adhesive layer was formed as in Example 1, except that the aqueous dispersion type pressure-sensitive adhesive was not degassed.

### Comparative Example 2

A pressure-sensitive adhesive layer was formed as in Example 1, except that the feeding under reduced pressure was not performed after the aqueous dispersion type pressure-sensitive adhesive was degassed.

The pressure-sensitive adhesive layers obtained in the examples and the comparative examples were evaluated as described below. The results of the evaluation are shown in Table 1.

### <Air Bubbles in the Pressure-Sensitive Adhesive Layer>

Air bubbles present in the pressure-sensitive adhesive layer (10 m² in area) were observed for number and size visually and with an optical microscope. The maximum bubble length (μm) and the rate (/m²) of the number of air bubbles with a maximum length of 50 μm or more are shown in Table 1.

### <Observation of Defects>

The pressure-sensitive adhesive layer (23 μm in thickness) obtained in each of the examples and the comparative examples was sandwiched between 38 μm thick polyethylene terephthalate films (MRF38 manufactured by Mitsubishi Polyester Film Corporation) by bonding both sides thereto, so that a sample was obtained. A polarizing plate (TEG-DU manufactured by NITTO DENKO CORPORATION) was placed on the sample, and from the polarizing plate side, it was visually determined whether or not any air bubble defect was present, and the result was evaluated according to the following criteria.

◯: No air bubble was visible.

x: An air bubble or bubbles were visible.

TABLE 1

| | Pressure-sensitive | | | |
|---|---|---|---|---|
| | adhesive layer | | | |
| | | Rate of the | | |
| | | number of air | | |
| | Maximum | bubbles with a | | Dissolved |
| | bubble | maximum length | | oxygen |
| | length | of 50 μm or | Appearance | content |
| | (μm) | more (/m²) | defect | (mg/L) |
| Example 1 | 60 | 0.2 | ◯ | 0.55 |
| Example 2 | 55 | 0.1 | ◯ | 0.80 |
| Comparative | 300 | >1000 | X | 5.75 |
| Example 1 | | | | |
| Comparative | 100 | 5 | X | 3.80 |
| Example 2 | | | | |

### DESCRIPTION OF REFERENCE CHARACTERS

In the drawings, reference numeral 1 represents a degassing apparatus, 2 an aqueous dispersion type pressure-sensitive adhesive, 3 a buffer tank, 4 a connecting pipe, 5 a pump set tank, 7 a vacuum pump, 6 a connecting pipe, 11 a closed tank, 13 a vacuum valve, 31 a closed tank, and 51 a closed tank.

1. A pressure-sensitive adhesive layer, comprising a product formed by applying an aqueous dispersion type pressure-sensitive adhesive comprising a dispersion containing at least a base polymer dispersed in water and by drying the applied aqueous dispersion type pressure-sensitive adhesive,
the pressure-sensitive adhesive layer dose not contain air bubbles with a maximum length of more than 350 μm and the number of air bubbles with a maximum length of 50 μm to 350 μm is 1/m² or less in a surface of the pressure-sensitive adhesive layer.

2. The pressure-sensitive adhesive layer according to claim 1, wherein the base polymer in the aqueous dispersion type pressure-sensitive adhesive is a (meth)acryl-based polymer.

3. The pressure-sensitive adhesive layer according to claim 2, wherein the (meth)acryl-based polymer as the base polymer is a product of emulsion polymerization.

4. A pressure-sensitive adhesive member comprising a base substrate and the pressure-sensitive adhesive layer according to claim 1 provided on one or both sides of the base substrate.

5. The pressure-sensitive adhesive member according to claim 4, wherein the base substrate is an optical film.

6. A method for manufacturing the pressure-sensitive adhesive member according to claim 4, comprising the steps of:
(1) degassing an aqueous dispersion type pressure-sensitive adhesive comprising a dispersion containing at least a base polymer dispersed in water;
(2) applying the aqueous dispersion type pressure-sensitive adhesive, which has undergone the degassing step (1), to one or both sides of a base substrate; and
(3) drying the applied aqueous dispersion type pressure-sensitive adhesive to form a pressure-sensitive adhesive layer, wherein
the degassing step (1) is performed in a tank of a degassing apparatus,
the aqueous dispersion type pressure-sensitive adhesive is supplied to the applying step (2) using a pump set tank that is connected to the tank of the degassing apparatus through a connecting pipe, and
the aqueous dispersion type pressure-sensitive adhesive having undergone the degassing step (1) is fed from the tank of the degassing apparatus to the pump set tank, while pressures are each set in such a manner that a pressure in the pump set tank and a pressure in the connecting pipe are each 1 kPa to 50 kPa lower than a pressure in the tank of the degassing apparatus.

7. A method for manufacturing the pressure-sensitive adhesive member according to claim 4, comprising the steps of:
(1) degassing an aqueous dispersion type pressure-sensitive adhesive comprising a dispersion containing at least a base polymer dispersed in water;
(2) applying the aqueous dispersion type pressure-sensitive adhesive, which has undergone the degassing step (1), to one or both sides of a base substrate; and
(3) drying the applied aqueous dispersion type pressure-sensitive adhesive to form a pressure-sensitive adhesive layer, wherein
the degassing step (1) is performed in a tank of a degassing apparatus,
the aqueous dispersion type pressure-sensitive adhesive is supplied to the applying step (2) using a pump set tank that is connected to the tank of the degassing apparatus through a buffer tank and a connecting pipe,
the aqueous dispersion type pressure-sensitive adhesive having undergone the degassing step (1) is fed from the tank of the degassing apparatus to the buffer tank, while pressures are each set in such a manner that a pressure in the buffer tank and a pressure in the connecting pipe are each 1 kPa to 50 kPa lower than a pressure in the tank of the degassing apparatus, and
the aqueous dispersion type pressure-sensitive adhesive in the buffer tank is fed from the buffer tank to the pump set tank, while pressures are each set in such a manner that a pressure in the pump set tank and a pressure in the connecting pipe are each 1 kPa to 50 kPa lower than a pressure in the buffer tank.

8. The method for manufacturing the pressure-sensitive adhesive member according to claim 6, wherein the aqueous dispersion type pressure-sensitive adhesive after the degassing step (1) has a dissolved oxygen concentration that is 15% or less of a dissolved oxygen concentration of the aqueous dispersion type pressure-sensitive adhesive before the degassing step (1).

9. The method for manufacturing the pressure-sensitive adhesive member according to claim 6, wherein the aqueous dispersion type pressure-sensitive adhesive being applied in the applying step (2) has a dissolved oxygen concentration of 3 mg/L or less.

10. The method for manufacturing the pressure-sensitive adhesive member according to claim 6, wherein the base substrate is an optical film.

11. An image display, comprising at least one of the pressure-sensitive adhesive layer according to claim 1.

12. An image display, comprising at least one of the pressure-sensitive adhesive member according to claim 4.

13. The method for manufacturing the pressure-sensitive adhesive member according to claim 6, wherein the aqueous dispersion type pressure-sensitive adhesive after the degassing step (1) has a dissolved oxygen concentration that is 15% or less of a dissolved oxygen concentration of the aqueous dispersion type pressure-sensitive adhesive before the degassing step (1).

14. The method for manufacturing the pressure-sensitive adhesive member according to claim 7, wherein the aqueous dispersion type pressure-sensitive adhesive being applied in the applying step (2) has a dissolved oxygen concentration of 3 mg/L or less.

15. The method for manufacturing the pressure-sensitive adhesive member according to claim 7, wherein the base substrate is an optical film.
